(19) United States
(12) Patent Application Publication
(10) Pub. No.: US 2015/0106284 A1
(43) Pub. Date: Apr. 16, 2015

(54) SYSTEM AND METHOD FOR A USER ONLINE EXPERIENCE DISTILLING THE COLLECTIVE KNOWLEDGE AND EXPERIENCE OF A PLURALITY OF PARTICIPANTS

(71) Applicants: Zeev Rubinstein, Tel Aviv (IL); Itai Herman, Tel Aviv (IL); Jonathan Hemi, Fresh Meadows, NY (US); Tomer Zakai, Tel Aviv (IL)

(72) Inventors: Zeev Rubinstein, Tel Aviv (IL); Itai Herman, Tel Aviv (IL); Jonathan Hemi, Fresh Meadows, NY (US); Tomer Zakai, Tel Aviv (IL)

(73) Assignee: Askem Tlv Ltd, Tel Aviv (IL)

(21) Appl. No.: 14/050,386

(22) Filed: Oct. 10, 2013

(51) Int. Cl. G06Q 50/00; G06Q 30/02

(52) U.S. Cl. CPC G06Q 50/01; G06Q 30/0201
USPC 705/319

(57) ABSTRACT

A method of determining an answer. The method includes sending a question through a mobile network to a plurality of mobile terminals, receiving responses to the question from the mobile terminals and outputting a single answer based on the responses.

### RELATED APPLICATION

This application claims priority under 35 U.S.C. § 119(e) to U.S. Provisional Application No. 61/712,275, filed Oct. 11, 2012, which is hereby incorporated by reference in its entirety.

### FIELD OF THE INVENTION

The present invention generally relates to the online user experience, and more particularly to a system and method for a user online experience that effectively distills the collective knowledge and experience of a plurality of participants.

### BACKGROUND OF THE INVENTION

The Wisdom of Crowds: Why the Many Are Smarter Than the Few and How Collective Wisdom Shapes Business, Economies, Societies and Nations, published in 2004, is a book written by James Surowiecki about the aggregation of information in groups, resulting in decisions that are often better than could have been made by any single member of the group. The book touches on several fields, primarily economics and psychology.

Source: Galton, Francis (1907 Mar. 7). “Vox Populi”, Nature|James Surowiecki, “the wisdom of crowds”

The origin of the idea relates to Francis Galton's surprise in 1907 that the crowd at a county fair accurately guessed the weight of an ox. When their individual guesses were averaged, the average was closer to the ox's true butchered weight than the estimates of most crowd members, and also closer than any of the separate estimates made by cattle experts. A diverse collection of independently deciding individuals is likely to make certain types of decisions and predictions better than individuals or even experts, and the central theory draws many parallels with statistical sampling.

Oinas-Kukkonen captures the wisdom of crowds approach with the following eight conjectures:

1. It is possible to describe how people in a group think as a whole.

2. In some cases, groups are remarkably intelligent and are often smarter than the smartest people in them.

3. The three conditions for a group to be intelligent are diversity, independence, and decentralization.

4. The best decisions are a product of disagreement and contest.

5. Too much communication can make the group as a whole less intelligent.

6. Information aggregation functionality is needed.

7. The right information needs to be delivered to the right people in the right place, at the right time, and in the right way.

8. There is no need to chase the expert.

Source: http://en.wikipedia.org/wiki/The_Wisdom_of_Crowds#cite_note-2#cite_note-2

### SUMMARY OF THE INVENTION

Accordingly, the present invention provides a method of expression and interaction based on digital media and user inputs, so that the user input enriches the digital media and targets it to the user's desires, wherein the method is utilized to enrich content prior to crowd-wisdom based analysis.

In additional embodiments the present invention provides a method of profiling and segmentation of users based on behavioral pattern matching and user content.

In additional embodiments the present invention provides a method of qualitative and quantitative measurement and assessment of crowd wisdom networks based on repeated standardized tests.

In additional embodiments the present invention provides a method of perfecting answers aggregated from crowd wisdom networks based on user feedback, user profiling and answers weights.

In additional embodiments the present invention provides methods and a system of providing statistically significant right answers based on qualitative and quantitative assessed crowd wisdom networks enriched by user profiling.

The system can provide answers to factual questions such as the weight of an ox, but can also provide valuable, insightful feedback to users, at least as valuable and effectual as Snow White's “mirror, mirror on the wall.” The following is an example of how the system receives relevant information and what is does with it:

“HOW ARE YOU?” Question..

Using a slider to determine the mood of the user.

Collecting user mood data on a daily basis.

Collecting (server side) aggregated user mood data from different users. Categorizing this data according to nationality, geographic location, gender, time of day, time of year, in relation to events in the news, declared topics of interest, number of friends, etc.

Collect data on the relation of mood answer to other questions and answers.

Present feedback to the user according to his stated mood, and according to the change of mood from the previous mood declaration.

Importing images with visual information from user's social networking activity, recognizing and assessing valuable details and applying results to personal questions posed by the user as well as generally providing potentially helpful feedback to the user:

The ability to import images from a user's Instagram, Facebook, twitter and other social networks (in addition to standard behavior of importing from local device or capturing new images). Turning imported images to square images automatically.

The ability to tag points of interest in an image as possible answer to a question.

Automatically detecting points of interest: faces, objects etc. and allowing the user to specify their contents or automatically determine their contents.

The key assets of the user experience of the present invention:

Fun and easy to use; and

All about asking the right questions:
Image hotspots
Easy to use sliders.

The present invention enables one to know instantly what thousands of people think, choose or do, literally about everything in which one is interested. People in the aggregate are smarter. That's a fact.

Crowds are able to pin point an ox's weight almost to the pound and the number of grains in a sack of wheat almost to the grain. 90% of the crowd answers on ‘Who wants to be a millionaire’ proved to be correct. Crowd intelligence\‘wisdom of crowds’ is based on the formula:

plim s(n)p⁽⁰⁾(n)=μ

n→∞

According to large sample theory:
An estimator of parameter μ is said to be consistent, if it converges, where lim refers to the limit in probability (p) to the true value of the parameter as the number of individuals in the crowd goes to infinity (∞), i.e, becomes a “very large number.”
As with convergence in probability, almost sure convergence makes sense when the random variables s(1), . . . , s(n), . . . and s are all defined on the same sample space.

Providing Super Right Answers is the core challenge.

Sharing.data is the primary asset. The present invention provides “Super Right” Answers by:

Profiling assisted answer aggregation.

Dynamic topic base scoring.

Answer quality assurance.

Network quality assurance.

In a preferred embodiment, as described below, with reference to FIG. 3, the present invention provides meaningful, significant answers to questions. Each respondent is profiled to enable forecasting the probability of representing a segment/sub-segment of the population defined by demographics or other attributes such as age, gender, interaction with a topic, friends, culture etc.

A “birds-eye” algorithm calculates aggregate weighted information from various data sources to a specific question. The calculation for each of the pre-specified answers to a question for a specific segment is based on various combinations of at least some of the following steps:

1) Preset data supplied by users and 3^{rd} party service

2) User Topics Probability Matrix (UTPM)—a dynamic analysis of user's interaction with topics in the past (upto t=now).

3) Topics Relations Matrix (TRM)—a dynamic analysis of relations between topics in the system (the probability that user that can forecast the majority/targeted group answer to a question regarding cars to forecast the majority/target group regarding SUV's)

4) Dynamic data—data regarding trends, time, geo location, social network profile analysis, life cycle of the question (behavior and status up to now (t=now) etc.

5) Question relation Matrix (QRM)—a dynamic/static analysis of relation between questions in groups.
a) A user submits a question which he would like answered (for example: question number 6699)
b) The user specifies the segmentation criteria for his question.
   Segmentation criteria consist of one or a combination of the following:
membership criteria such as gender, age etc;
topic interaction criteria that list the level of interaction this group has with a topic, for example, high interaction with sports and law or interaction with environmental issues;
topic representation level criteria, i.e., the probability one's answer will represent the answer of the general public or a subset of it.
segments are logical conditions and as such can be structured into logical sentences using Boolean algebra.

c) Answers are presented as an aggregation of the answers by respondents that fulfill the segmentation criteria, each answer of a respondent is weighted, based on the users representation score (from the UTPM) under the question topics and/or topics that are related to this question (from the TRM).

d) A question can be clustered to a single analysis (using the QRM) in order to perfect the output and reduce noise.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIGS. 1a-1d are screenshot illustrations of questions being asked, constructed according to an exemplary embodiment of the present invention;

FIG. 2 is a screenshot illustration of the interactive elements used in conjunction with a simple question being asked, constructed according to the principles of the present invention; and

FIG. 3 is a flow diagram illustrating the profiling of each respondent to coordinate with forecasting the probability of representing a segment/sub-segment of the population, constructed according to the principles of the present invention.

All the above and other characteristics and advantages of the invention will be further understood through the following illustrative and non-limitative description of preferred embodiments thereof.

### DETAILED DESCRIPTION OF PREFERRED EMBODIMENTS

The principles and operation of a method and an apparatus according to the present invention may be better understood with reference to the drawings and the accompanying description, in which like numerals designate corresponding elements throughout, it being understood that these drawings are given for illustrative purposes only and are not meant to be limiting.

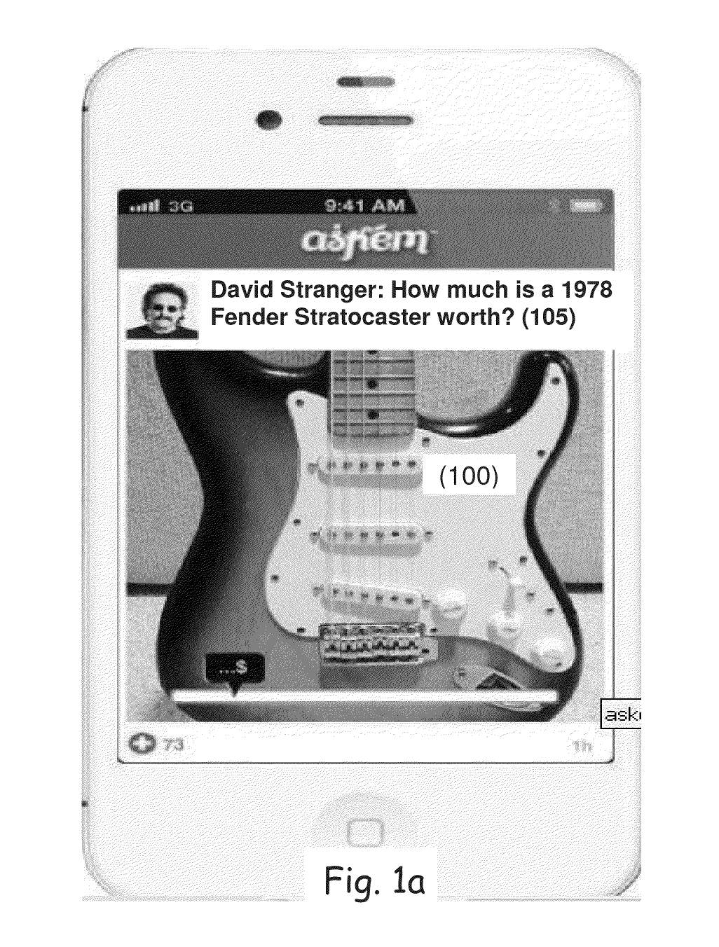

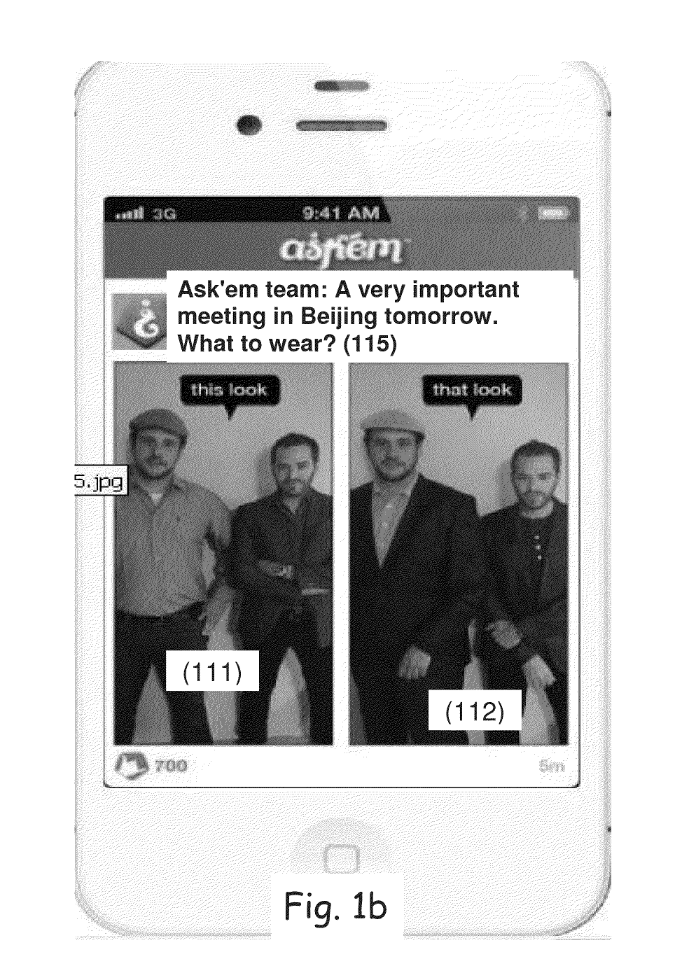

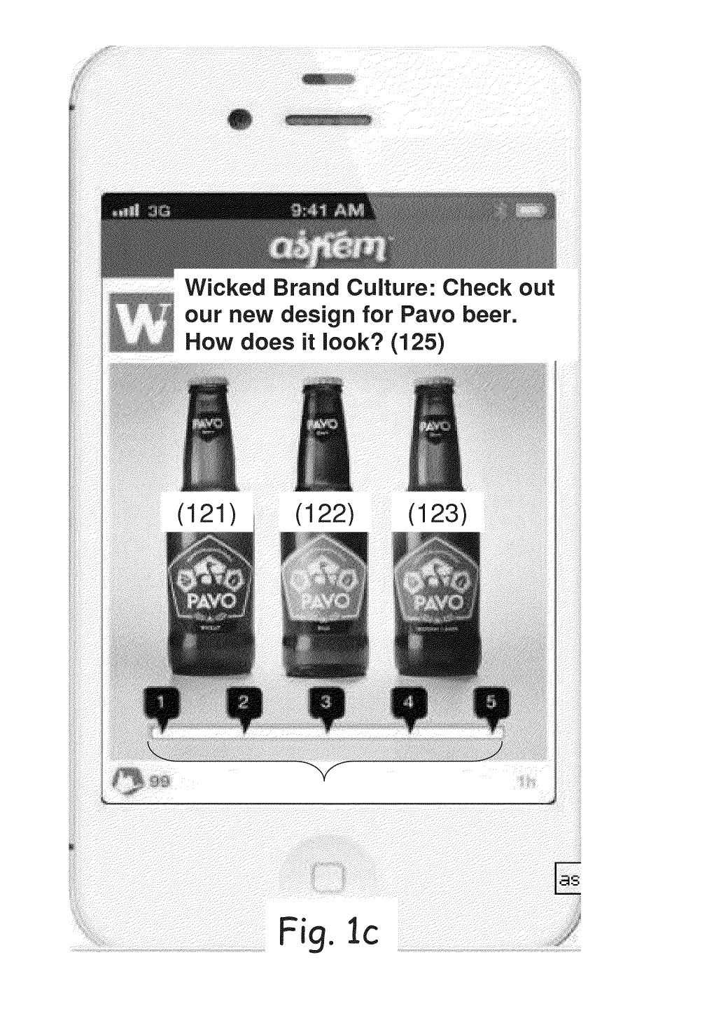

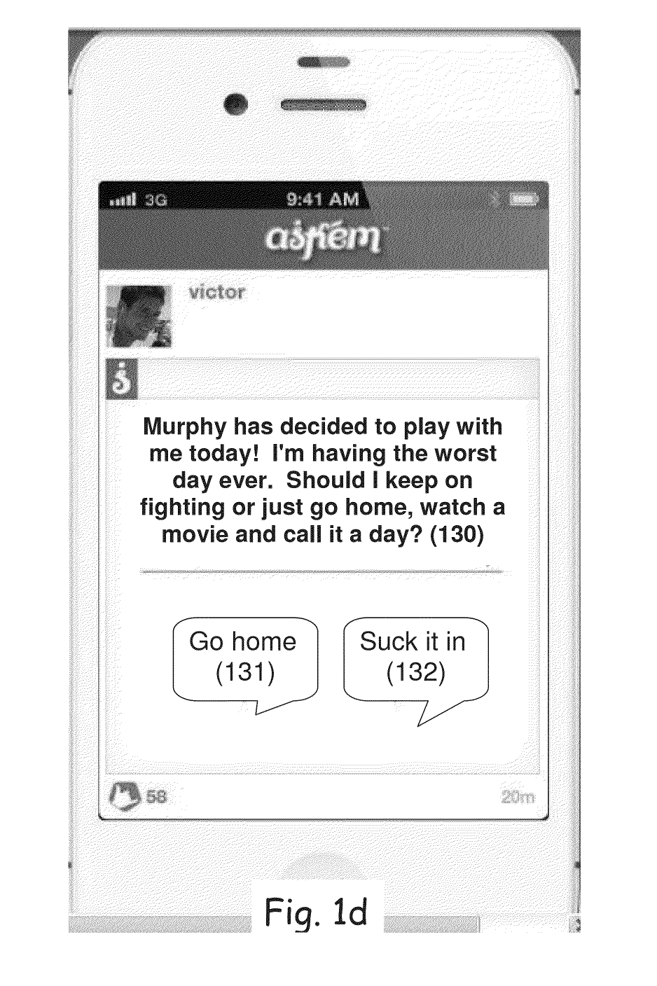

FIGS. 1a-1d are screenshot illustrations of questions being asked, preferably using people's smartphones (e.g., iPhones or Android phones) or similar devices, constructed according to an exemplary embodiment of the present invention. In FIG. 1a a Fender Stratocaster is pictured 100 and David Stranger asks: How much is a 1978 Fender Stratocaster worth? 105. In FIG. 1b members of the Ask'em team are pictured in two different poses 111 and 112. They ask: A very important meeting in Beijing tomorrow. What to wear? 115.

In FIG. 1c three flavors of Wicked Brand Culture Pavo beer are pictured 121, 122 and 123: The question is asked: Check out our new design for Pavo beer. How does it look? 125. In FIG. 1d Victor asks: Murphy has decided to play with me today! I'm having the worst day ever. Should I keep on fighting or just go home, watch a movie and call it a day? 130. Two choices are provided for replying: “Go home” 131 and “Suck it in? 132.

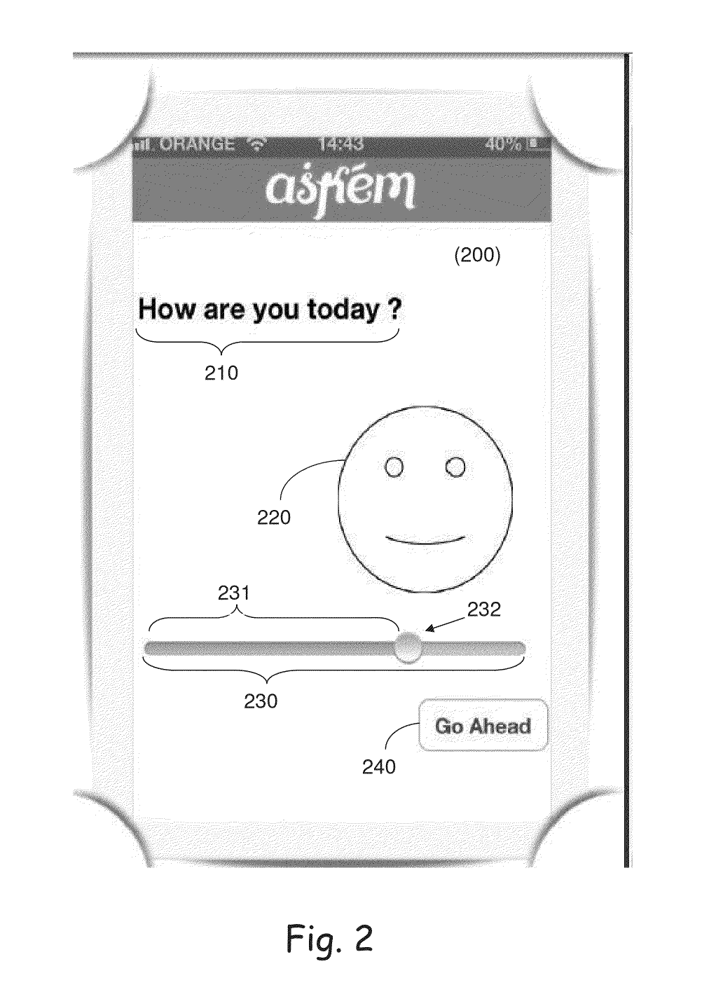

FIG. 2 is a screenshot illustration of the interactive elements used in conjunction with a simple question being asked 200, constructed according to the principles of the present invention. The question is simply “How are you today.” The response is symbolized by emoticon 220, where the smile represents a generally good mood. A slider 230 is used to register one's response 231 as a proportion of the total length of slider 230, by positioning slider element 232 according the mood from extremely bad on the left to extremely good on the right. To register one's response, “Go Ahead” 240 is clicked.

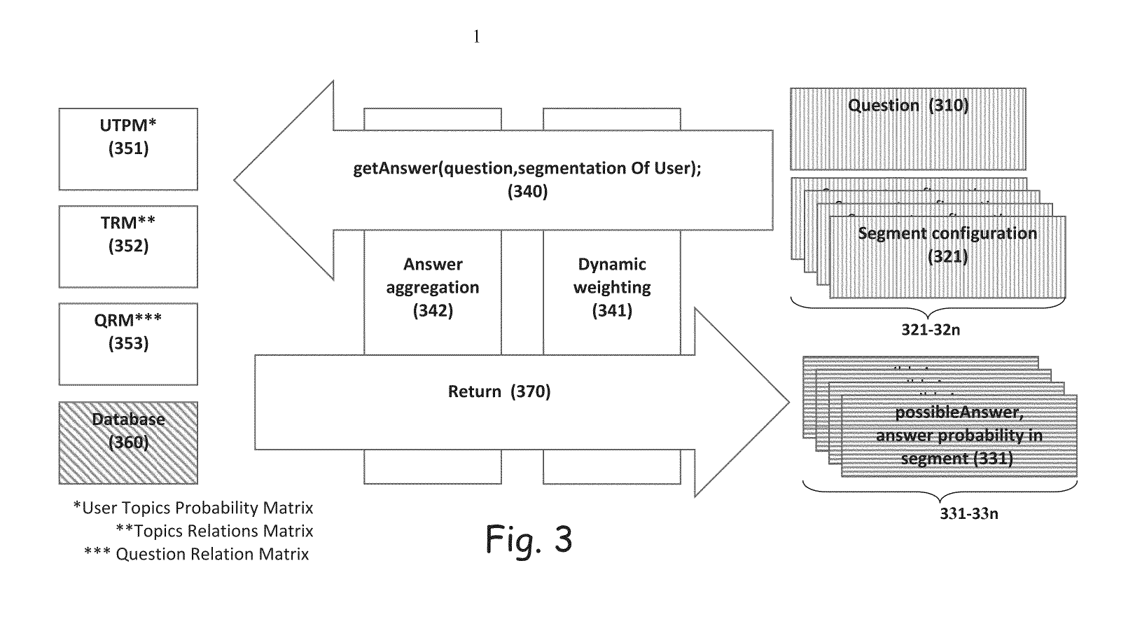

FIG. 3 is a flow diagram illustrating the profiling of each respondent to coordinate with forecasting the probability of representing a segment/sub-segment of the population, constructed according to the principles of the present invention. A new question, or alternatively a previously developed and stored question is entered to the algorithm 310 along with information gathered for each respondent and his/her response. In a segment configuration step, each respondent is assigned to one or more of the appropriate demographics or other attributes 321-32n. For each answer, along with assigned categories from among segment configuration 321-32n, a dynamic weight 341 is calculated and the answers are aggregated accordingly 342.

The User Topics Probability Matrix (UTPM) 351 is now derived for the current question. Table I shows UTPM 351 for an exemplary question. UTPM 351 dynamically maintains an individual score (0.0-1.0) for the probability of a user forecast the global answer under specific topic. The matrix score is based on past respondent answers compared to other past answers to this question.

TABLE I

| UTPM[user x] = User X | | | | |
|---|---|---|---|---|
| probability matrix | | UTPM probability matrix: | | |
| topic | Probability | topic | User 0 probability | User n probability |
| fashion | 70% | fashion | 70% | 12% |
| clubs | 87% | clubs | 87% | 3% |
| cars | 12% | cars | 12% | 99% |
| . . . | . . . | . . . | . . . | . . . |

The Topics Relations Matrix (TRM) 352 is now derived for the current question. Table II shows TRM 352 for an exemplary question. TRM 352 dynamically maintains a score for the probability that a user represents a particular segment of opinion on topic X. This score will manifest a given correlation with his ability to represent a segment of opinion on topic Y. That is, TRM 352 is compiled based on the analysis of past answers to questions under a variety of topics.

TABLE II

| | |
|---|---|
| TRM[sport] = sport | |
| probability matrix: | TRM: |

| topic | Probability | Topic\Topic | fashion | . . . |
|---|---|---|---|---|
| fashion | 70% | fashion | 70% | . . . |
| clubs | 87% | clubs | 87% | . . . |
| cars | 12% | cars | 12% | . . . |
| . . . | . . . | . . . | . . . | . . . |

The Question Relation Matrix (QRM) 353 is now derived for the current question. QRM 353 dynamically maintains a score reflecting the relationship between questions, such that the probability a respondent's answer to question X will affect his answer on question Y will be presented as QRM[X,Y]=n (0.0-1.0), or the probability vector of question x as QRM[X].

QRM 353 is maintained by the maintainer of the question database 360, including questions, question characteristics and auxiliary user/respondent data. The aggregate of possible answers and corresponding answer probabilities in each segment 331-33n are returned for display.

TABLE III

| TRM[x] = sport | |
|---|---|
| probability matrix: | TRM: |

| question | Probability | Question\question | 1 | . . . |
|---|---|---|---|---|
| | | | | . . . |
| 1 | 70% | 1 | 70% | . . . |
| 2 | 87% | 2 | 87% | . . . |
| 3 | 12% | 3 | 12% | . . . |
| . . . | . . . | . . . | . . . | . . . |

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method of forecasting answers, the method comprising:
sending a question or questions to a configured group;
receiving answers from the configured group; and
forecasting an answer based on profiles of members of the configured group.

2. The method of claim 1, wherein a profile of group member is dynamically built based on the actions of the group member compared to the actions of the other group members.

3. The method of claim 1, wherein profiles are optimized by relations between topics

4. The method of claim 1, wherein questions are predefined multiple-choice questions.

5. The method of claim 1, wherein questions are predefined open text questions.

6. The method of claim 1, wherein questions are open scale question.

7. The method of claim 1, wherein profiles are optimized by group member's interaction on social networks.

8. The method of claim 1, wherein profiles are optimized by group member's interaction on mobile devices.

9. The method of claim 1, wherein profiles are optimized by the location of the group members.

10. A system forecasting answers, the system comprising:
a server computer configured to send a question or questions to a configured group; receive answers from the configured group; and forecast an answer based on profiles of members of the configured group.

11. A method of gathering information from multiple sources to forecast an answer to a query, the method comprising:
receiving a query from a first user;
broadcasting the query to multiple second users, each of said second users having an individual user profile derived from the usage history of the respective second user;
receiving responses to the query from said second users;
processing the received responses to determine how to forecast how a group larger than the group of second users would respond to the first user's query, the determination deferring at least in part more to responses from one or more of the second users than to responses from the remaining second users, the deference being based on the user profiles; and
sending a response to the first user, the response being the result of said processing.

12. The method of claim 11, wherein the first user sends the query using a smartphone.

13. The method of claim 11, wherein the first user sends the query via a social network.

14. The method of claim 11, wherein the individual user profiles of the second users is repeatedly updated based on usage history.
